(19) United States
(12) Patent Application Publication
(10) Pub. No.: US 2016/0141878 A1
(43) Pub. Date: May 19, 2016

(54) DC APPLIANCE SYSTEM

(71) Applicant: JOHN ANTON JOHANSEN, KAILUA-KONA, HI (US)

(72) Inventor: JOHN ANTON JOHANSEN, KAILUA-KONA, HI (US)

(21) Appl. No.: 14/933,838

(22) Filed: Nov. 5, 2015

Related U.S. Application Data
(60) Provisional application No. 62/122,992, filed on Nov. 5, 2014.
(60) Provisional application No. 62/179,311, filed on Apr. 29, 2015.

(51) Int. Cl. H02J 3/38

(52) U.S. Cl. CPC H02J 3/383; H02J 3/386

(57) ABSTRACT

The Embodiments herein produce a net zero electric system (where there is no grid utility electricity required) and/or reduce substantially the size of the balance of plant such as batteries, the consumption of electricity, the generation of electricity or the use of grid electricity. The management system uses cold air storage, thermal storage in water heaters, and increases the efficient of the systems.

The Solar and Wind hybrid production system uses DC electricity in appliances without converting to AC to reduce battery, inverter and charge controller size, cost and Operation and Maintenance (O&M) expenses (On and/or Off-Grid Balance of Costs major components are depicted in FIG. 3) and without requiring the solar/wind electricity going through battery chargers and batteries reducing costs and increasing efficiency.

The applicant has applied for two Provisional Patent Applications which this patent application merges into and incorporates: Provisional Application No. 62/122,992 Filed Nov. 5, 2014 and No. 62/179,311 filed Apr. 29, 2015.

### FIELD

The field is Solar and Wind energy.

### BACKGROUND OF THE INVENTION

FIG. 1 shows a typical interconnection to the utility after electricity is produced from either solar or wind energy Array, converted from Direct Current (DC) electricity by an Maximum Power Point Tracker (MPPT) inverter, and whose electricity is use by the house through the main breaker. FIG. 2 typical off-grid system, without an interconnection to the utility, shows electricity produced from the Solar Photovoltaic or Wind Array, converted to the AC electricity by a MPPT Inverter, and batteries are used to power the electricity for the house through a charge controller. The Maximum Power Point Tracker (MPPT) Charge Controller charges the battery with Direct Current (DC) electricity. In any case, the DC electricity either is converted to AC for use, is used by other Appliances or stored in DC batteries.

The Patent Application herein proposes using Solar and Wind DC system with DC electricity in appliances and some AC electricity with their own inverters without use of the primary inverter converting the DC electricity to AC. This design reduces battery, inverter and charge controller size, cost and Operation and Maintenance (O&M) expenses (On and/or Off-Grid Balance of Costs major components are depicted in FIG. 3). The embodiments herein share the electricity from the DC appliances and AC appliances with their own inverters.

As an example, one DC appliance is a hot water solar hot water system and another is a solar air conditioner. In contrast, the conventional way solar hot water system, whether passive or active, produces by solar collectors thermal fluid and uses the fluid to heat water. Conventional Passive Solar Hot Water relies on convection or heat pipes to circulate water (direct system) or heat transfer (indirect system) between a solar collector and a storage tank. The active systems use a pump to circulate the water (direct system) or heat transfer fluid (indirect system) between a solar collector and a storage tank. The Passive Solar and Active Solar systems are Solar Thermal Systems rather than Solar Electric Systems. A DC solar hot water system is an appliance where one or more heating elements operate on Direct Current (DC). Similarly a DC air conditioner operates on Direct Current and/or Alternating Current (AC). This type of appliance also benefits from a system that controls the excess or unused solar and/or wind electricity, maximizes output through reductions in efficiency losses and reduces cost by reducing the components of the system involved.

### DESCRIPTION OF THE DRAWINGS

FIG. 1 is a Typical On-grid Photovoltaic System with Optional Battery.

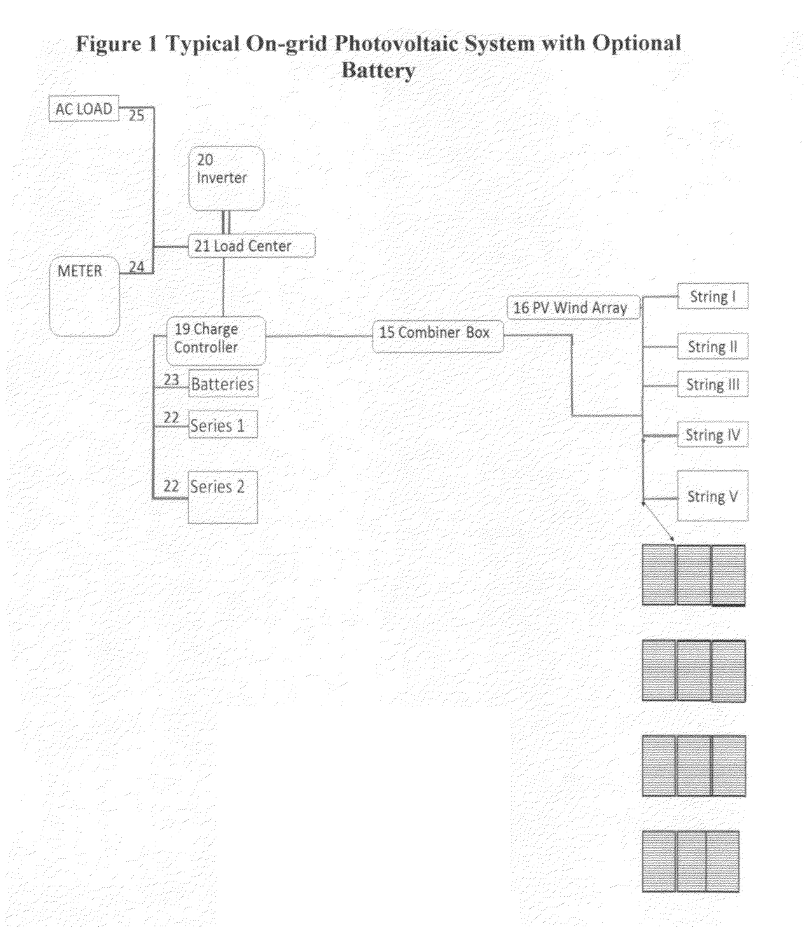

FIG. 2 is a Typical Off-Grid Photovoltaic System with Batteries and

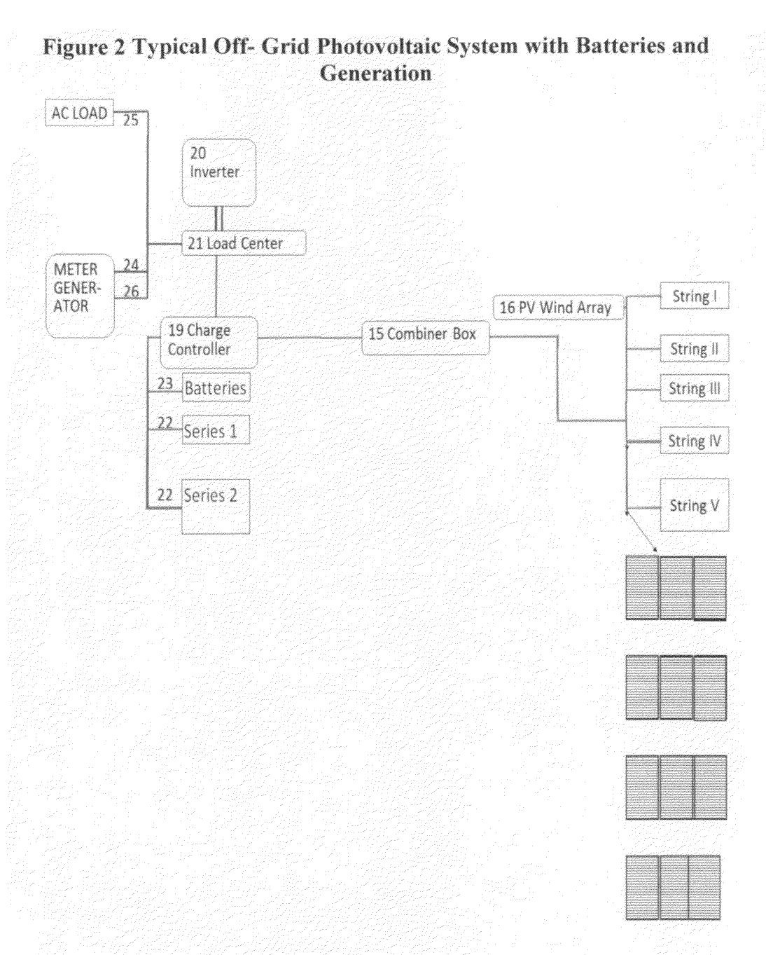

FIG. 3 is On and/or Off-Grid Balance of Cost of Typical System by Component

FIG. 4 DC Appliance System One Line Electrical Drawing with two separate Arrays

FIG. 5 Solar Output by Volts/Amps of Solar DC Electric Hot Water System

FIG. 6 DC Solar Hot Water On and Off-Grid One Line Electrical Drawing with One or more Arrays

FIG. 7 Reference Information on Wind Energy production pattern in Nevada

FIG. 8 Typical Exhaust Capacity and Dimension for varying sized Wind Turbine Ventilators

FIG. 9 Wind Turbine Ventilator without Generator

FIG. 10 Permanent Magnet Generator (PMG) Power Curve by RPM and Watts

FIG. 11 Wind Turbine Ventilator with Generator

FIG. 12 DC Appliance Maximizer One Line Electrical Drawing with one Array

FIG. 13 DC Appliance Maximizer One Line Electrical Drawing with one Array and Optional Batteries.

### DESCRIPTION OF TECHNOLOGICAL SPECIFICATIONS OF THE INVENTION

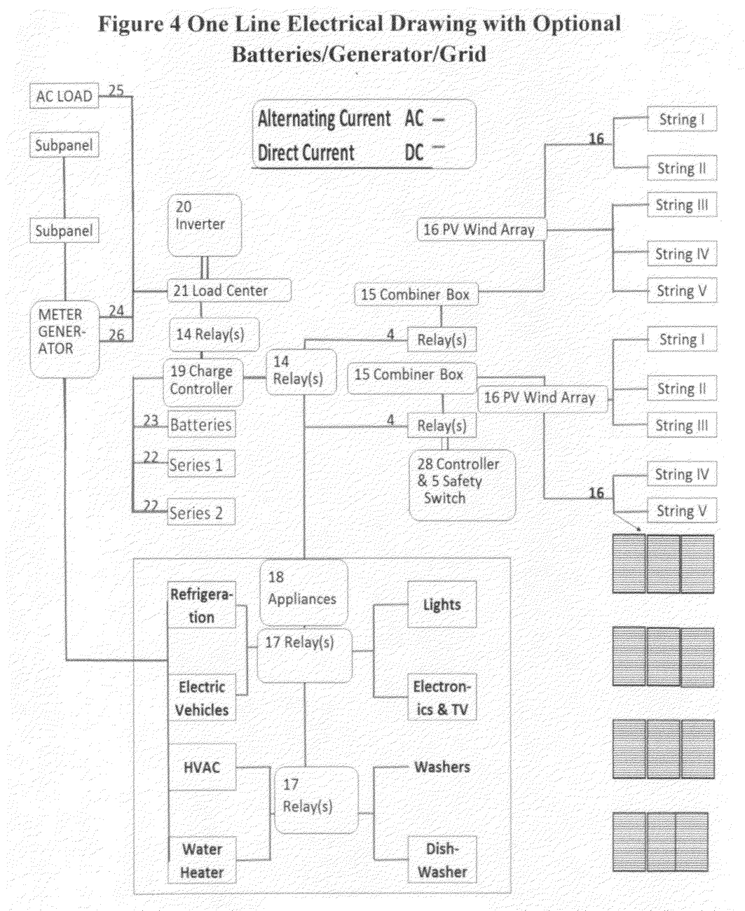

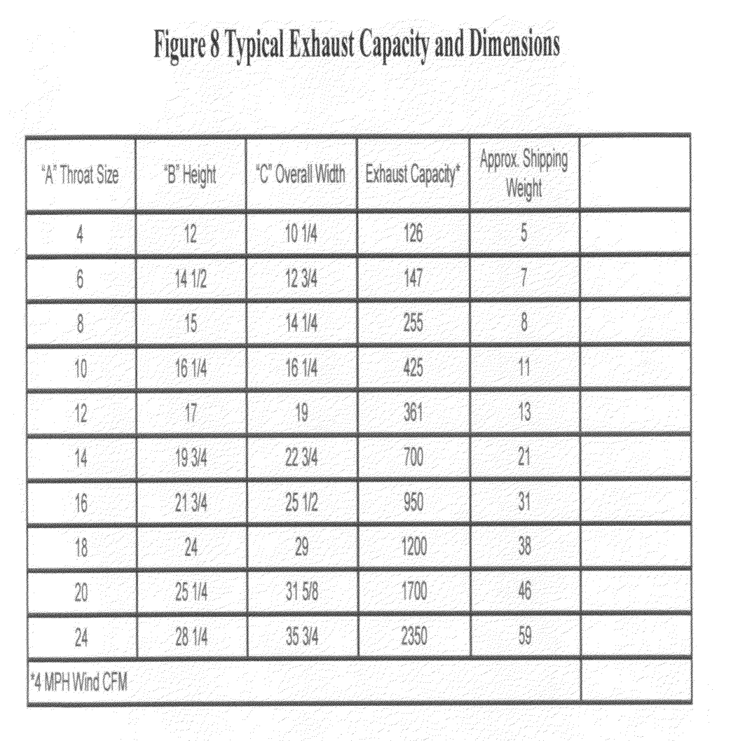

The following description including Figures and Exhibits are a detailed description of the technology by major claims divided by Claim Area I, II, & III and independent patent claim descriptions from I, IX through XIII. The claims are made within each Claim Areas and are cross referenced herein and include the Figure item numbers (01) to (13) in the paragraphs referring to key components identified on FIGS. 4, 5, 6, 7, 8, 9, 10, 11, 12 and 13 incorporated herein and embodiments and technology described herein as follows:

Describe herein are systems and methods (ie. Utilities) that allow for the use and production of renewable energy systems. Each of the patent claim relate to the field of PV solar energy and wind energy areas in order:

Technology Description:

Area I. DC Appliance System with Higher Efficiency and Lower Cost Uses Excess Electricity Not Needed from DC Appliances.

This embodiment is the use of DC Appliances and the excess electricity above what is required to operate DC appliances (Appliance) as shown including lights, fans and/or DC Hot Water systems and redirecting such electricity to other appliance; to redirect solar/wind electricity to other DC appliances directly, to sell such power to the grid and lastly to invert such electricity to AC electricity use.

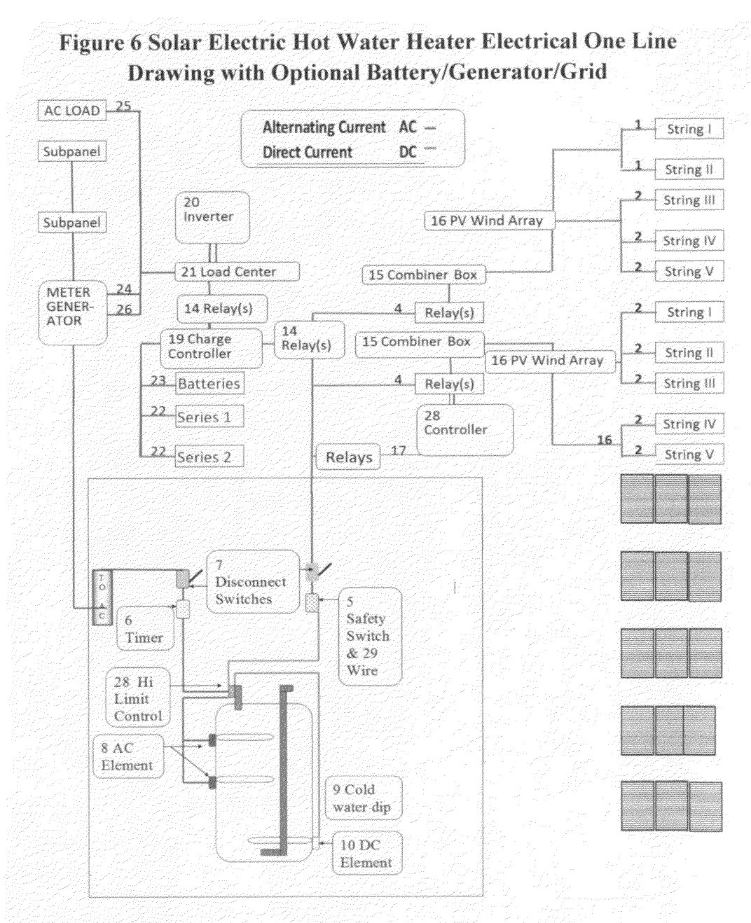

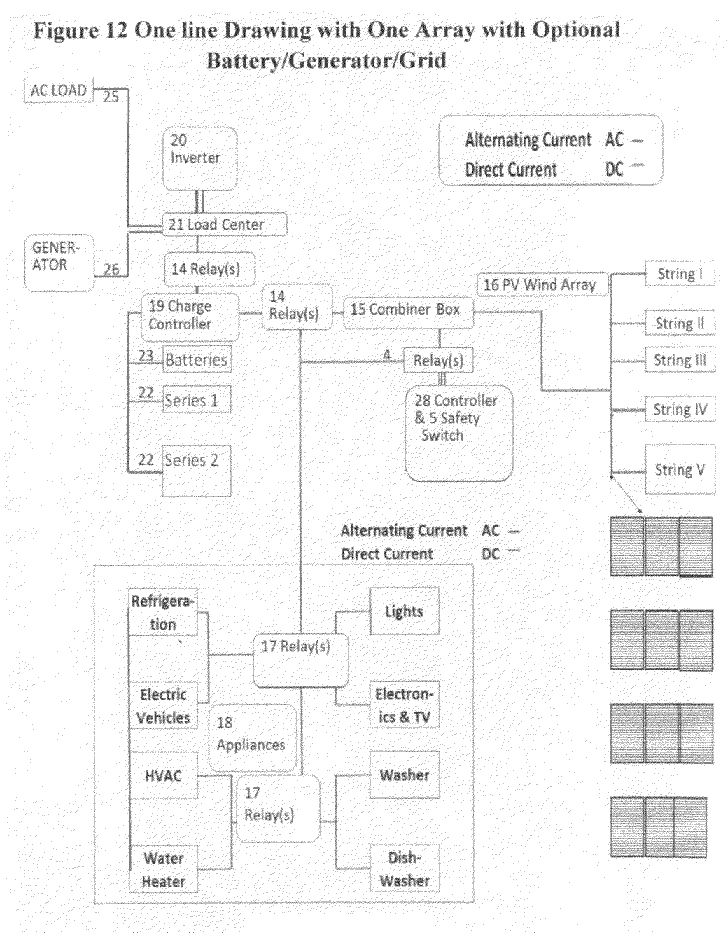

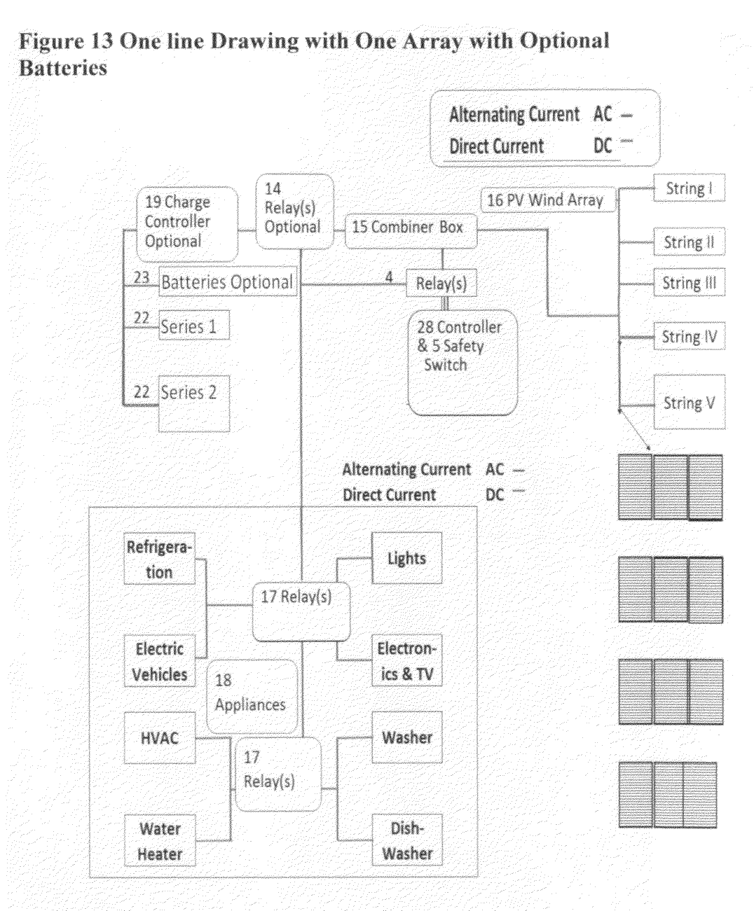

FIG. 4, FIG. 6, FIG. 12 and FIG. 13 are electrical one line diagram for how excess electricity above what is required to operate a DC appliance, many of which are shown in item 18, and/or Solar Electric Hot Water Heater, Heat Pumps and Heat Pump Water Heaters (Appliances) can be used to charge batteries, use excess electricity, and sold or banked with the utility once the primary use in an appliance, or hot water heater of the renewable energy such as solar and wind generated electricity (item 16) has been achieved it purpose. There are two array in FIG. 4 though more than two can be used herein; the top one that is conventional going into a combiner box with breakers (15) and then Load Center (21). There is one array in FIGS. 4, 6, 12 and 13 though the number of arrays can vary. At the Load Center the electricity can go through the inverter (20) and be used for a load or sold and/or banked with the utility or it can charge the batteries (22) using the charge controller (19). In FIGS. 4, 6, 12 and 13 the Load Center (21), the inverter (20), the utility grid (24) or the batteries (22) using the charge controller (19) are Optional and are not needed to operate the system.

The bottom electrical circuit goes into a combiner box with breakers (15) and then to a Direct Current (DC) Appliance (18) some of which are shown in FIGS. 4, 6, 12 and 13 and/or DC Hot Water, Heat Pump DC compressor. One, two or more circuits as shown can be used for this system as the embodiments described herein.

When the appliance does not need the electricity for any reason; a controller opens the circuit for relay number 2 (17) from a signal from the controller(s) (28) so no electricity flows through to the Appliance and/or Solar Electric Hot Water Heater (18). Simultaneously or right before or prior; relay (4) and (14) closes circuit from a signal from the controller(s) (28) so electricity flows through to the Load Center (21) going to the MPPT inverter or non MPPT inverter(2) to convert to AC electricity and use or flowing electricity into the grid or direct battery charging (22). Since the electricity has not been inverted to AC when charging the batteries, the charging can be completed without AC/DC conversion loses and use of an inverter. The batteries (22) can be any type of battery including the lead acid shown FIG. 4.

4, 14 & 17. Relay or Contactor. The Solar and/or Wind Array electricity is wired to a contactor, relay or other disconnect devise (Contactor) (4) (14) and (17) in FIGS. 4, 6, 12, and 13. The contact has a coil or other device which opens or closes the Solar and/or Wind Array circuit. The contactor in this case is UL recognized. The contactor disconnects the PV Solar and/or Wind Array by opening the coil. It connects the circuit and allows the Solar and/or Wind Array to produce electricity (amps, volts, watts, ohms, etc.).

(003) 5. Emergency and Fire Safety Switch.

A button switch (5) specifically designated along side the controller or integrated into the controller has been incorporated. It is wired directly into one wire of the 24 VDC or other voltage/current circuit chosen. The switch will for safety, fire, O&M and emergency reasons break the nominal control voltage circuit which then opens the (4) contactor coil and turns off the Solar PV and/or Wind array electricity production or redirects the wind turbine production to a dump load. The (4) Contactor is located within ten feet of the array for Fire Safety though it could be located anywhere on the Solar and Wind Array (16) VDC electricity wire (in this case 150 VDC) without meeting this code. The contactor is rated for rapid shutdown and meets NEC 690.11 and 690.12 DC arc fault interrupting and rapid shutdown requirements. Again this a key patent design features having an integrated Emergency and Fire Safety Switch into the design of the controller.

(004) 28. Set Point Switch, & Electrical Amps, Volts Controller. Controller (28) is used as a Thermostat and/or Electrical Parameter switch to turn off, redirect, limit or reduce the Solar and/or Wind Electric Module Array when the appliance or hot water tank has reached its desired use or set temperature. As an example an Solar Air Conditioner set point might turn off when the temperature has reached a low reading of 68 degrees. Another example a solar electric hot water tank might turnoff when it has reached a high temperature of 125 degrees. At the time the controller turns off the appliance; the electricity that is produced or could be produced is wasted. The Controller has a temperature sensor attached, though it could be wireless or separate, on a communication wire which can be extended and is attached to the water tank. Alternatively, in the tanks or other temperature sensors currently used such as but not limited to a thermistors can read temperature.

The controller 28 also can measure volts, amps, watts, ohms, and other electrical measurements such as impulses. The communication wire with temperature sensor and the nominally 10 gauge wires (=/−) or other sizes are installed, attached or wireless into the Water Heater or Appliance. Alternatively, the controller can use measurements of volts, amps, watts, ohms, and other electrical measurements (collectively in this sentence above “Electrical Parameters”) to limit, reduce, turnoff or redirect production to DC appliances (18), other any DC electrical use including but not limited to battery charging (19), resistive heat sources, electronics, lights, refrigerators, air conditioners, etc., the Load Center (21) and Inverter (20) for use on the AC portion of the house by switching the relays (4, 14, and 17) and sending DC electricity to the Battery Controller (19) and/or Load Center (21) circuits.

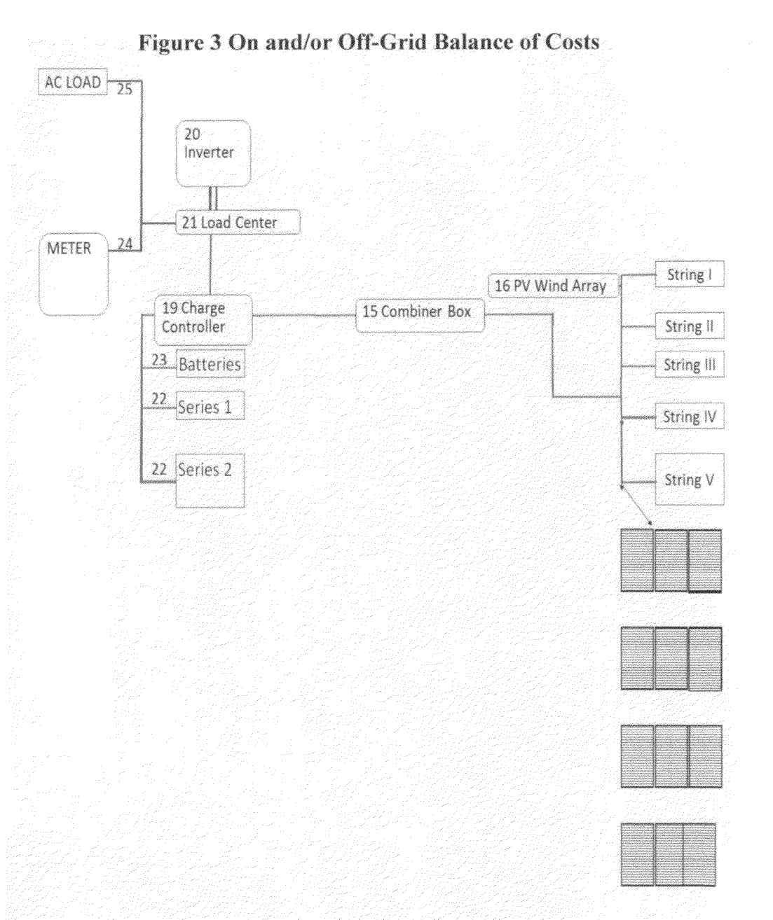

This system shares by operation of the controller the electricity produced from each independent DC Appliance (18) through the circuitry shown. This is significant because it reduces the balance of plant system size and cost in FIG. 3.

The Batteries DC (22) electricity is controlled by Controller (28), Battery Charger (19), Load Center (21), or any other controller to go through the Battery Charger, Load Center, directly, or other circuitry to provide DC electricity to the DC appliances (18), Hot Water Heater, DC Air Conditioner, etc. increasing efficiency of the system and reducing costs. Alternatively electricity can be directed from the Meter (24) to DC appliance increasing efficiency by reducing inverter efficiency loss.

(005) The high or low temperature limit Setpoint (HTSP) or (LTSP) respectively is the highest or lowest temperature the appliance is allowed to reach. The high or low limit Setpoint is the highest or lowest volts, amps, watts, ohms, or other electrical parameter (Electrical Parameter) the appliance is allowed to reach. Once the set point is reached, the controller opens up the circuit, closes the circuit and closes more relay's, contactor or other circuit devices, coil and circuit to the nominally 120 VDC circuit. The controller sets the Electrical Parameter or Setpoint and when it reaches it will stop providing a nominal 23/24 VDC or other range of voltage, amps and/or current to the contactor. The Contactor without the voltage will open the coil which opens the nominal 120 VDC circuit or other voltage used turning off the Solar and/or Wind Array (16) electricity production. The controller will again provide the nominal 24 VDC or other voltage when it reaches a new Setpoint or Electrical Parameter as programed which closes the coil and circuit. If the circuit is broken by definition it shuts off the Solar PV and Wind array (16), and/or reduces or redirects the solar and wind electricity to the Load Center (21), Battery Charger (19), or utility grid (24). Wind turbines, unlike, solar arrays require a dump load because the unit does not stop producing electricity when the circuit is turned off. The redirection of the wind electricity serves as a dump load.

The Controller operates on nominal 120 AC, 240 AC, 12 VDC, or 24 VDC or other matching voltages including these as does the contactor though this voltage and DC/AC can fluctuate by equipment chosen. For example, 23 VDC is accepted by both the Controller and Relay. Any temperature setpoint, voltage limit, amps limit, watts, or other measureable setpoint can be programmed by the device to have the PV or Wind array start to produce, reduce, redirect, or limit electricity or entirely shutdown that production.

(006) The controller has several additional key safety and patent claims. The setting “are saved in non-volatile memory which means they will stay programmed even if the power is cut to the unit”.

Another safety features in is built in If utility and battery power goes off to the controller the contactor (4) will automatically open the circuit by shutting off nominal 24 VDC electricity to the coil and the Solar and Wind Array (16) stops producing electricity. This is a key safety provision of the patent.

Yet Another safety features in is built in is that the controller has more than a three year backup battery supply which means even if the utility power goes off the controller will keep functioning and controlling the temperature.

Another safety features in is built in that the controller has a Hidden Access Menu Functions which is also a key safety provision of the patent. These functions limit the temperature changes and differentials a consumer can make. The HTSP is set to 5 F below the maximum of this manufactures rating (145 F which will vary by manufacturer and design) which cannot be exceeded by the user in the Programming Temperature Set Point menu they see. The differential temperature which is nominally 10 F (can be varied by programing and design) is set also which does not allow the Solar and Wind Array (16) to turn back on until nominally 135 F. The Operating Mode, heat, or cool is set in this hidden function. The temperature unit, C. or F., and calibration of that temperature can also set in this hidden menu.

(007) At the Load Center the electricity can (a) flow through the inverter (20) and be used for a load or sold/net meter banked with the utility through the meter (24) and/or (b) it can charge the battery or batteries (22) using the MPPT charge controller (19) and later be used or flow through the battery or batteries to the Load Center (20), directly to DC Appliances (18) and MPPT inverter (20). The Controller(s) 28 uses various Electrical Parameters and/or temperature sensors to decide whether to open or close circuits.

AREA II OF THE SYSTEM. DC Electric Hot Water Systems

(008) Solar Electricity Water Heaters to date use Alternating Current (AC) inverted from Direct Current (DC) to power electrical heating elements. The solar electricity uses an inverter to transform the DC electricity to AC electricity and using conventional hot water heater thermostat controller or electrical to heat hot water is not new and has been sold for a long time overseas. The embodied system herein, however, uses Direct Current (DC) electricity for hot water with electrical wires transfers that electricity to an electrical hot water tank's DC heating elements or to a DC compressor in a Heat Pump Water Tank system to produce hot water or thermal heat in fluid or air (Element) or air conditioning. The use of an all DC electrical hot water system with DC controller, DC heat pump compressor, DC relays, DC battery charger and DC elements is in the embodiment herein. This DC system has significant cost, efficiency and charging advantageous.

Alternatively, some elements can be DC from the Solar/Wind Array (16), some dedicated to batteries, and some dedicated to AC such as generators, and/or Grid.

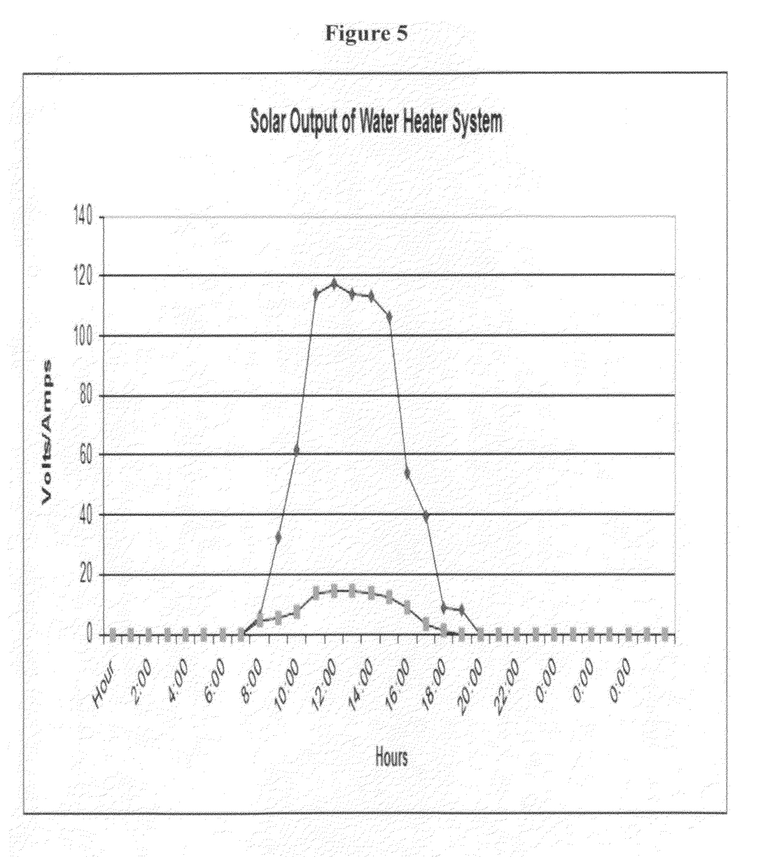

(009) FIG. 5 is recorded output data from a solar DC electrical hot water heater with data. An independent testing facility for Solar Rating Certification Corporation (SRCC) has also recorded similar data on this system. The recorded data in 2012 exceeds the manufacturer DC rating of the modules during that peak period showing high efficiency in cold temperatures.

The demonstration system used a 120 volt heater element electrically matched to Solar Electric Module capacity of 1800 watts and 120 volts. In the operating hot water heater system the lower heating element is rated at 120 volts, 16.62 amps and 2000 watts. We can use one, two, three or more heating elements in the same hot water Tank. Other test data is recorded by the Independent Laboratory commissioned for Solar Rating Certification Corporation. FIG. 5 shows the output in volts and amps of the solar electric hot water system. The volts in FIG. 5 are shown on pink line and the amps in blue line. The technique used to allow solar electric and wind electric to heat the water heater without grid power requires the balancing of the heater element rated watt, volt and amp capacity with the solar electric and wind electric rated watt, volt and amp capacity. These results are matched well by Technique, Formula's and Pattern claims with the heater element we installed as described mathematically by formula and by procedure in Appendix 1.

In the operating units the lower heating element is rated though voltage can vary at 48, 60, 90, 120, 130 and 150 volts DC. The amps are 20 amps and 1400, 2000 and 3100 watts which are matched electrically by the solar modules. There are many examples of the Techniques and Patterns to match the production with the load. Voltages just in these few examples range from 24 volts to 1000 volts. Systems can be made up from a few amps to more than 1000 amps using these same techniques. Amps also have a wide range but also have to be matched to the load using this system. Watts can vary from 50 to over 100,000 watts.

(010) 12. Solar & Wind Electric Hot Water Heater. The DC Electric Water Heater is to be used for heating water in conventional electric, fossil fuel, oil, propane and gas water heaters. This saves energy thereby reducing the electric bill but the system also has a built in backup heater element which provides hot water when there is little solar energy. The Solar Heater uses direct current (DC) electricity produced from Solar Electric Modules to produce hot water through conventional heater elements. This system compares or is not the same as many others who used DC Solar with inverters or micro inverters converting it to AC current or household current which is conventional way to produce electricity for solar electric hot water tanks and uses AC designed heater elements and thermostat controller.

The Solar Electric Heater stores that hot water in conventional hot water heaters. Solar Electric Hot Water Heater comes in a wide range of voltages including but not limited to the following: 12, 24, 48, 60, 90, 120, 130, 150, and 220/240 volt DC for the solar and Wind electricity or other DC voltage and 120/240/208 volt AC Backup electricity or other grid voltage. One is grid connection and the other is not and they are both separate circuits as shown in FIGS. 6, 4, 12 and 13. The water heater has three elements in this proposal but alternatives with any number of elements can be used. The top two elements are connected to AC grid electricity conventionally or Battery DC electricity. The bottom element is connected to the Solar Electric Array usually but other elements can be connected. Any elements can be connected above to any power supply.

(011) Item 1 & 2. Solar Modules and Wind Turbine. Any number of or types of solar Photovoltaic semi conductor materials, modules, voltages, amps or watts can be used. The data for this system used 4, 6, 10, 14, or 28 Sunworld 330 Watt polycrystalline units or a total of 1.32 kW, 1.98 kW, 3.3 kW, 4.620 or 8.4 kW of DC capacity matched to the heater elements load. The size of the Array (16) will vary. Output of each SunWorld modules is rated by the manufacturer at 36.1 volts, Pmax 300 watts, 44.5 Voc, 8.36 Imp Amps, and ISC 8.83 each or in series of three modules they produce 120 volts and 14.5 amps as shown in FIG. 4 item 16 calculations. One, two, three or more strings of 1 or more modules each are wired in series though alternative configurations can be configured as demonstrated (16) Array each. The strings and number of modules will vary. The volt produced will vary by solar manufacturer, strings, and models used. Wind turbines producing any volts or amps have also been used with this system including conventional horizontal axis, and vertical axis wind turbines. The wind turbine shown is part of this patent application and is described in area III though any wind turbine can be used.

(012) 5. Emergency and Fire Safety Switch. A button specifically designated along side the controller has been installed. It is wired directly into one wire of the nominal 24 VDC or other voltage/current circuit chosen. The switch will for safety, fire, O&M and emergency reasons can break the nominal control circuit which then opens the contactor coil and turns off the Solar PV array electricity production or redirects the wind turbine production to a dump load. The contactor is rated for rapid shutdown and meets NEC 690.11 and 690.12 DC arc fault interrupting and rapid shutdown requirements. Again this a key patent design features having an integrated Emergency and Fire Safety Switch into the design of the system.

(013) Item 6. Electronic or Mechanical Timer Switch. The system uses an electronic Time Switch or its mechanical equivalent to shutdown the backup electricity to the backup elements as shown in by setting and/or programs. These smart controllers are combined or separate from the controller. These timers are used for a variety of voltages including but not limited to 120/240 VAC and other voltage circuits. The timer interrupts through relays the nominal 120/240 volt water heater electricity to the water heater backup top and middle elements saving electricity when the solar unit is in operation or prior to having the solar unit in operation. In this case it is 240 Volts 30 amps. The timer can turn off and on the electricity by the time of the day for 5 day work schedule, weekend schedule, or individual day schedule with minute accuracy. The program schedule can be by-passed completely by switching to manual operation. The timer is power by the 240 volt power supply and has a minimum of three year battery backup to retain scheduling. The use of the timer increases the solar and wind percentage that the system produces by reducing the hot water the backup provides.

(014) Item 8 & 10. One or More Water Heater Elements. A three element electric water heater is shown in FIG. 6 though any number of elements could be used. The system backups (Backup) the hot water production with grid electricity, batteries, generators or fossil fuels such as natural gas, oil, and propane through an Energy Management System through one or more HEATING ELEMENT(s) (item 8 in FIG. 6) or any combination of the above. The Solar Heater uses direct Current (DC) electric energy from Solar Electric Modules, Wind Turbines, or batteries to produce hot water through electric heater elements. In this case we used the lower heating element though we could of used any element(s) place anywhere. In remote applications, the middle element would also be used as a heater element for DC electricity separately wired to an additional Wind or Solar Array (16). The system backups (Backup) the hot water production with grid electricity through an Energy Management System THROUGH THE UPPER and/or MIDDLE HEATING ELEMENT or any other element located anywhere. The Solar Electric Heater stores that hot water in conventional two, three or more element water heaters which allow for more than one-half of the tank to recover quickly using two or more backup elements.

We are using a AC or DC water heater element (10) or DC compressor of any watts and voltage which is match to the DC voltage. In the production unit it is a 120 Volt High Watt Density nominal 1400 watt, 2100 watt, 3000 watt, 4500 watt, or 5500 watt heater element or any range therein. The water heater element is designed to limit or regulated voltage so the system can be more efficient in the heater element size though it does not have to. The size of the voltage and wattage of the water heater element can vary by system design. The alternative water heater element used a non Resistored 2000 watt 120 volt or 240 volts and/or our DC designed 1400 watt, 2100 watt or 3000 watt hot water heater element. Either works but the resistored element, voltage regulator, resistors, or other voltage type regulation are higher efficiency when properly matched to DC voltage curve. We use AC or DC water heater elements on the backup depending if it is connected to the grid or a battery/generator system both with possible wind generation.

(015) Item 4. & 14. Relay or Contactor. The Solar and Wind Array (16) electricity is wired to a contactor, relay or other disconnect devise as shown in FIGS. 4, 6 and 12. The contact (4) has a coil or other device which opens or closes the Solar and Wind Array (16) circuit and the Solar Hot Water Heater (14). The contactor disconnects the PV Solar and Wind Array by opening the coil and connects the circuit which closes the coil. The Contactor is located within 10 feet or less of the Array (16) to produce electricity (amps, volts, watts, ohms, etc.) or the Solar ElectricHot Water to use DC electricity with its heating Element or DC compressor for the heat pump water heaters. The contactor (4) is located within one to ten feet of the array for Fire Safety located anywhere on the Solar and Wind Array (16) VDC electricity wire (in this case 150 VDC). It is listed for arc fault interrupting and rapid shutdown requirements of NEC 690.11 AND 690.12PV DC code by locating it where within 10 feet of the array. The contactor is rated by to disconnect up to 1000 VDC electricity though we are operating on nominally 120 VDC in this design or any other volts by design. The nominal 24 VDC though 23 VDC could be used communication wires from the Controller to the Contactor is controlled by a thermostat. If the voltage is interrupted by the Controller (24 VDC nominal operating voltage which can vary and does significantly by transformer) the electrical circuit of up to 1,000 VDC can be interrupted by the Contactor. A Disconnect Switch (item7) and fuses/breakers disconnects the backup water heater elements from the AC Grid and/or DC battery system and/or Generator.

(016) Item 12. Hot Water Heater Tank Changes. FIG. 6 has the Array directly connected to the Heating Water Element (14) as shown in FIG. 6. Thermostat heater element (8) heats first and then the middle Thermostat heater element (8) or in two elements water heaters the Upper Element (8) only. In this type of normal electric hot water system the DC electricity is wired directly to L1 and L2 input of an electric hot water system lower DC heater element (10) or Heat Pump Condenser after going through the Combiner box (15) and Relay (3). Any location could be used. One DC electrical line goes through the Contactor (14). This DC Solar system is not connected to the upper and middle thermostat system generally. The utility AC grid (24), DC batteries (22), or solar/wind array (16) or any element designated to be backup is connected as shown in FIGS. 4, 6 and 12. Any heater element in any position can be used for this purpose of backup. In FIG. 6, the Lower, and optionally the Middle/Upper elements is directly wired to the Solar and Wind Array (16). Additional elements in any position location maybe used for DC electricity in a water heater by changing the heater element and use of the system described herein for controlling by changing out the heater element, eliminating the AC thermostat and wires and then to match the solar modules electrically to heating element. The water tanks directly heats with solar electric modules electricity using nominally 120 VDC Direct Current by wiring it directly to the Heating Water Element and/or DC compressor for Heat Pump Water Heaters.

Item 16. Combiner Box & Fuses/Breaker Protection. The solar modules arrays of two wires (one for each string) is wired in the combiner box through DC fuses and/or breakers by the Combiner Box. The combiner box accepts up to three strings (though larger combiner boxes are available with lots of strings). This protects against arc, faults and sudden electrical surges by use of 150 VDC dual breakers-one for each string though fuses can be used. The breakers are rated for 15 Amps and 150 VDC. Larger and small breakers and fuses will be used depending upon system design.

(017) Item 28. High Temperature Limit Switch, & Electrical Amps, Volts Controller.

The Controller is used as a Thermostat to turn off, limit or reduce the Solar Electric Module Array when the hot water tank has reached its desired set temperature which including the following a key patent claims.

The Controller has a temperature sensor attached on a communication wire which can be extended and is attached to the water tank. Alternatively, in the tanks or other temperature sensors currently used such as but not limited to a thermistors can read temperature. The communication wire or wireless temperature sensor and varying electrical wires sizes are installed into the Water Heater from the top where the electrical wires are inserted and down to the lower element on the outside to read the temperature by attaching it to the tank. Alternatively, the controller can use volts, amps, watts, ohms, and other electrical measurements (collectively in this sentence above “Electrical Parameters”) to limit, reduce, turnoff or redirect production to other any electrical use including but not limited to battery charging, resistive heat sources, electronics, lights, refrigerators, air conditioners, etc.

The high temperature limit setpoint (HTLS) is the highest temperature the water tank is desired to reach. In this unit the program set the temperature at a nominally 145 F (any range of temperature can be set). Once the HTLS is reached which opens the coil and circuit to the nominally 120 VDC circuit turning off the solar electricity. We programed the controller to set the temperature of the water tank and when it reaches High Temperature Set Point (HTSP) or other electrical measured parameter, which has been set at nominally 145 degree F. or other temperature as programed, it will stop providing a nominal 24 VDC or other range of voltage, amps and/or current to the contactor. The Contactor without the voltage will open the coil which opens the nominal 120 VDC circuit or other voltage used turning off the Solar and Wind Array (16) electricity production. The controller will again provide the nominal 24 VDC or other voltage when it reaches a nominal 135 degree F. or other temperature as programed which closes the coil and circuit. If the circuit is broken by definition it shuts off the Solar PV array. This is the high temperature limit switch (HTSP). This direct connection to the Thermostat Controller through the Array Mounted Contactor and its use as a controller of the water tank temperature (including preventing overheating) turns off solar electrical production is a key patent claims. The Controller operates on nominal 120 AC, 240 AC, 12 VDC, or 24 VDC or other matching voltages as does the contactor though this voltage and DC/AC can fluctuate by equipment chosen.

(018) Safety and Code Requirements Any temperature setpoint, voltage limit, amps limit, watts, or other measureable setpoint can be programmed by the controller to have the PV or Wind array start to produce, reduce, redirect, or limit electricity or entirely shutdown that production. The controller program acts as a dump load for the wind turbine by redirecting the electricity.

The controller has several additional key safety and patent claims. First, The setting “are saved in non-volatile memory which means they will stay programmed even if the power is cut to the unit”. Secondly, if utility and battery power goes off to the controller the contactor will automatically open the circuit by shutting off 24 VDC electricity to the coil and the Solar and Wind Array (16) stops producing electricity. This is a key safety provision of the patent. Third, the controller has more than a three year backup battery supply which means even if the utility power goes off the controller will keep functioning and controlling the temperature.

Fourth, the controller has a Hidden Access Menu Functions which is also a key safety provision of the patent. These functions limit the temperature changes and differentials a consumer can make. The HTSP is set to 5 F below the maximum of this manufactures rating (145 F which will vary by manufacturer and design) which cannot be exceeded by the user in the Programming Temperature Set Point menu they see. The differential temperature which is nominally 10 F (can be varied by programing and design) is set also which does not allow the Solar and Wind Array (16) to turn back on until nominally 135 F. The Operating Mode, heat, or cool is set in this hidden function. The temperature unit, C or F, and calibration of that temperature can also set in this hidden menu.

8, 26 & 29. Grid or Off-Grid. We are using either Grid utility electricity or as shown off-grid Generator and Batteries to power the Controller and backup heater elements (8). The system can operate without grid power.

29. Wire. We are using Solar PV wire rated by UL4703 for the connection from the Combiner Box through the Contactor to the Water heater. Normal PV wire approved by the electrical code can be substituted except for the wire coming out of the water heater tanks which requires high temperature wire. The special PV wire can operate between −40 F up to 257 F according to the specification sheet more than meeting manufacturer's specifications.

29. Special Connectors and Plug to together Unit. Connectors which are not compatible with MC4 commonly used in PV are used to connect the wire between the Combiner Box and the water heater element. These connectors allow the unit to be put together with a simple plugs and use. These connectors cannot connect into a MC4 connector preventing wrongly connecting parts such as combiner boxes, contactors, timers or water heaters to the PV system. This is a plug and play or use system.

III. Diversified Production with Wind Energy and New Simple Wind Turbine

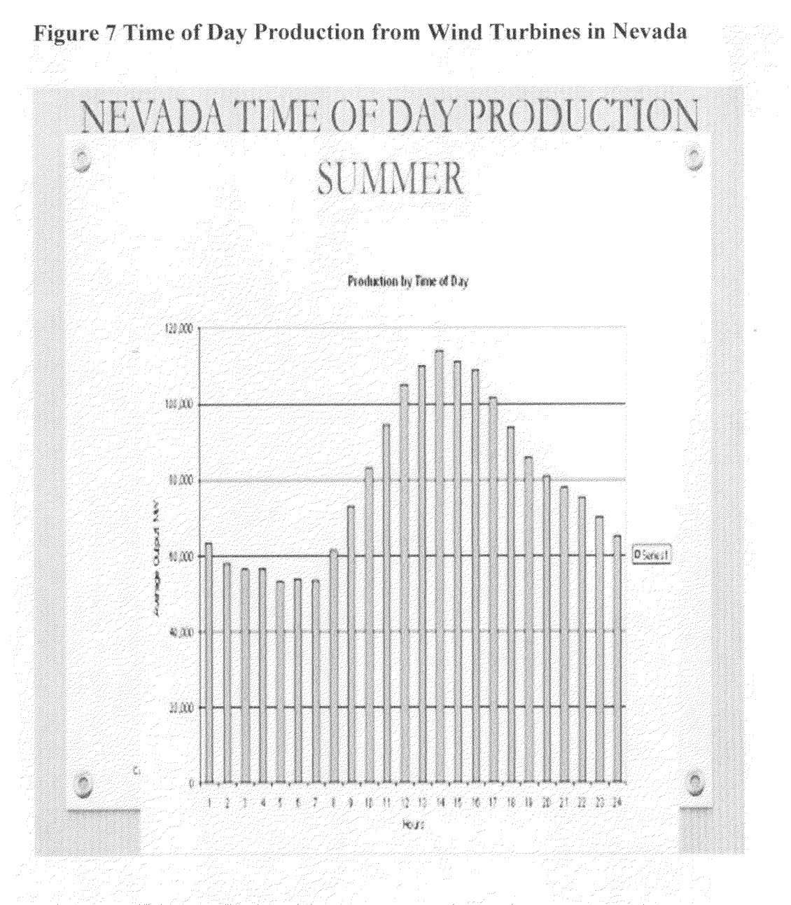

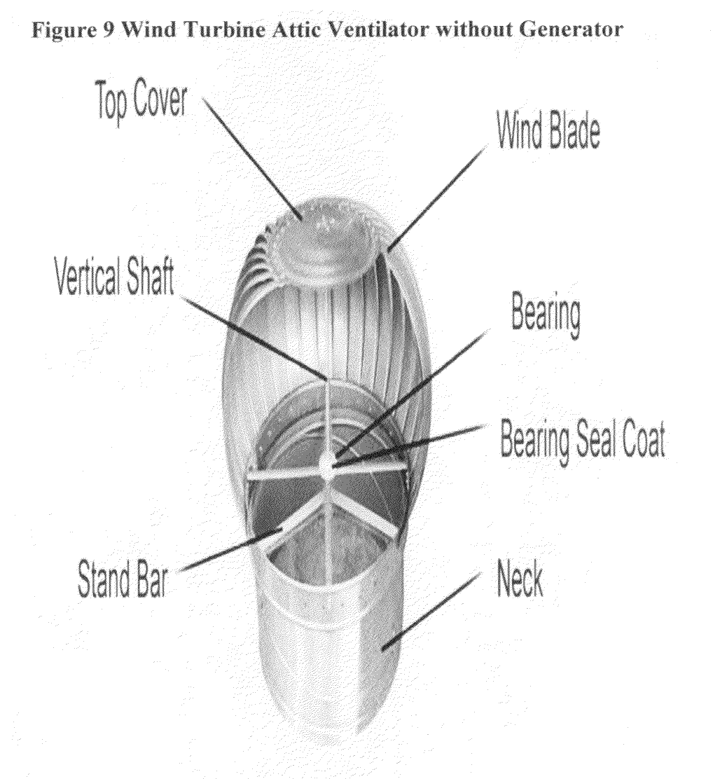

Time of Day Production from wind turbines contrasts sharply from solar production as shown in FIG. 7 and FIG. 5. Wind turbines, provides intermitten night time production, and day time. Production when it is cloudy augmenting the solar day time production. A wind turbine production can reduce the size and cost batteries (22) and inverters (20) by providing the valuable production above the solar (019) Wind Turbine Ventilator as a Wind Turbine. The problem with wind turbines in cities is the high cost of tower, high installation costs, finding a location to install a tower that neighbors like, the noise produced and esthetics. We have developed a new type of wind turbine that is fast easy to install, parts already in manufacturing and cheap to produced using wind turbine ventilators of all types, sizes and dimensions already accepted by the public in general. A typical wind turbine ventilator used to exhaust hot air from attics for houses, commercial buildings, farm buildings, industrial buildings, and other buildings (Structure) is shown in FIG. 9 with the typical Exhaust Capacity per size of wind turbine ventilators.

(020) Wind Turbine Production. This turbine would primarily produce DC electricity though AC electricity generators could be used. The type of wind turbine depends on generator type. This esthetically acceptable wind turbine design is important because lot of people oppose wind turbine power plants and the use of wind turbines especially in cities. This design is acceptable to most people. It is a vertical axis but also ventilates the attic of the structure and sometime interior space. The wind turbine ventilator exits heat from the attic and generators electricity at the same time. It is used in FIGS. 4, 6, 12, and 13 as a generator of DC electricity to reduce battery and inverter size and associated costs.

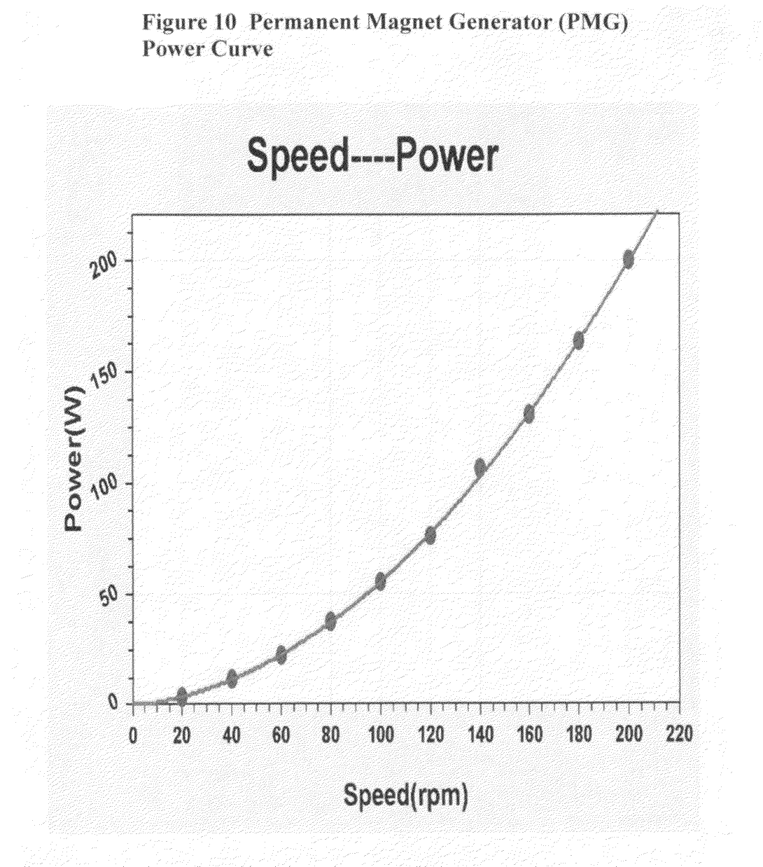

While any electrical generator, alternator, or other electrical generation devise (Generator) could be used with a wind turbine ventilator; we use a low or medium revolutions per minute (RPM) Permanent Magnetic Generator (PMG). The PMG or other Generator of any type produces electricity by its rotations as measured in RPM; the more power output per RPM at lower wind speeds generally the higher the efficiency. The PMG can be cordless which starts up in low wind speeds, is highly efficient as shown in FIG. 10, light weight, low starting torque and compact using direct drive technology designed.

Braking Type. The survival speed for the wind turbine generator is approximately 90 mile per hour meeting most residential codes. The system uses centrifuge slowing, and electromagnetic brakes (run the generator in reverse). The wind turbine generator could also use feathering out of the wind or the blades and mechanical brakes with this configuration. There are a Centrifugal wheel intelligence deceleration device inside the head of the generator. It will make the wind turbine generator to slow during overspeed and high wind events causing the turbine to output normally within the range of rated rotated speeds (RPM). The uniqueness of the design is that it unlike to reach survival and very high wind given the placement and design allowing for continued trouble free operation. In combination with the other ways to control speed the controller reduces the turbine RPM significantly by using the methods above to reduce, limit or stop the shaft rotation (RPM).

Wind Turbine Production. The production of the wind turbine, for example, is shown in FIG. 10 by the speed in revolutions per minute (RPM) and power electrical output in watts. While one of these can be used on an array in FIGS. 4, 6, 12 and 13 we generally use multiple units in an arrays (16) connected together in series or parallel like solar modules are with strings going into a combiner box (15).

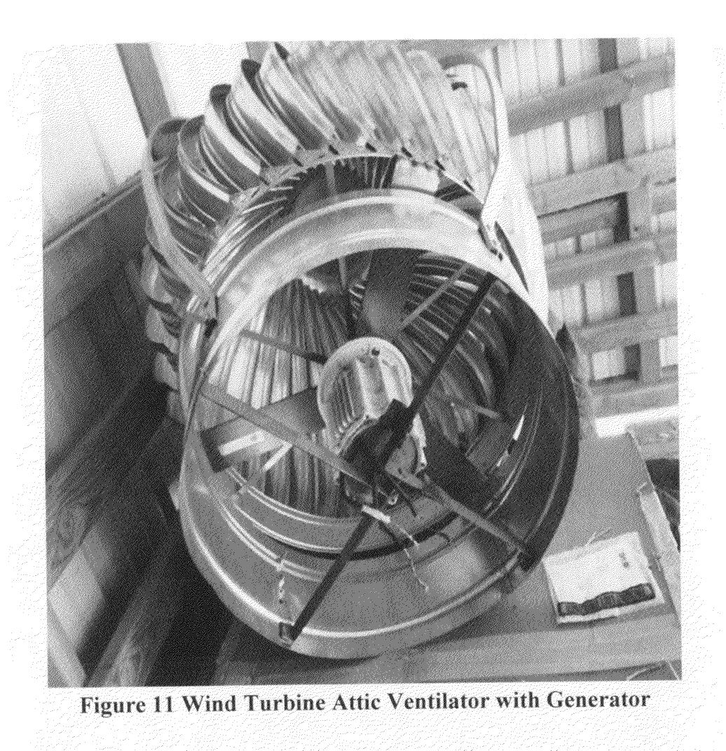

(021) Easy Structural Connection. The Generator, by being attached by flanges to the outside lower rim of the turbine and/or by the shaft, increases that survival speed by slowing the rotation. The wind turbine ventilator, as shown in FIGS. 9 and 11, is attached directly, though gears could also be used, to the generator at the bottom of the ventilator as shown.

This wind turbine generator attaches the same as a Wind Turbine Ventilator to the roof of a structures with a flange and opening on the bottom to ventilate the structure. The height of the wind turbine can be extended by extending the tube higher. This reduces tower structure, and installation time to a few hours expenses dramatically and is analogize to how solar modules install on roofs.

(022) 28. Controller. The controller (28) used can be the same as in FIG. 4, 6, 12, 13 or separate, as described in Section I, II and herein and described herein (002, 003, 014, 015, and/or 017) directs electricity to the DC load center (21), DC Appliances and/or DC Electric Water Heater (18), DC batteries (22) and/or grid (24). This system is a built in DC dump load for electricity produced from the Wind Turbine when the Appliance and Hot Water Heater storage (18) are not needing the electricity as shown in FIGS. 4, 6, 12 and 13. The generator, through the controller, can be rotated (RPM) to exhaust heat at night using battery and/or Grid electricity by the thermostat controller (28).

4, 14 & 17. Relay or Contactor. The Wind Array (16) electricity is wired to a contactor, relay or other disconnect devise (Contactor) (4). The contact has a coil or other device which opens or closes contactor(s) on the Wind Array circuit. The contactor disconnects the Wind Array (16) by opening the coil and stopping electricity from flowing. It connects the circuit and allows the Solar and Wind Array (16) to produce electricity (amps, volts, watts, ohms, etc.)

### APPENDIX 1 SYSTEM TECHNIQUES, FORMULA'S AND PATTERN (TECHNIQUES) EXAMPLES

This first system results are matched well by Technique and Pattern with the heater element we installed as described mathematically in this Appendix 1. The demonstration system used a 120 volt heater element electrically matched to Solar electric module capacity of 1800 watts and 108 volts. In the operating hot water heater system Exhibit A, the lower heating element is rated at 120 volts, 16.62 amps and 2000 watts. We use the techniques below:

### A. Sizing Techniques Example for 110 Volt Single Water Tank System

| | | Wind Or | Wind Or | Wind or | PV or Wind | | |
|---|---|---|---|---|---|---|---|
| | System | Module | Module | Module | per | No. Of | Amps per |
| | Volts | Voltage | Wattage | Amps | String | Strings | String |
| PV Production | 110 | 36.1 | 300 | 8.310249307 | 3 | 2 | 8.310249307 |
| Wind Production | 56 | 56 | 500 | 8.928571429 | 2 | 0 | 8.928571429 |
| 236 Volts | | | | | 3 | 3 | |

| | | | | |
|---|---|---|---|---|
| | | | | Water |
| | | | | Heater |
| Per Line | Total | Total | Total | Element |
| Amps | Lines | Modules | Amps | Wattage |

| | | | | | |
|---|---|---|---|---|---|
| PV Production | 16.62049861 | 1 | 6 | 16.620499 | 2000 |
| Wind Production | 0 | 1 | | 0 | Element |
| 236 Volts | 16.62049861 | | | | Voltage |
| | | 2 | 6 | 16.620499 amps | 120.3333333 |
| | | | Volts | 110 | |
| | | | Watts | 1,828.25 | |

A second example, in a 220/240 volt water heater element of 5,500 watts and 25 amps you can match as shown in Exhibit B. The close match is one string of up to 6 modules of 220 volts (1.36 amps each string) for a total of 8 amps in series wiring. This analysis is shown by technique calculation (Technique) specifically in Exhibit D-3. We matched these solar electric modules with two 110 volt wind turbines in series to total 220 volts and a total of 9.09 amps. The total of 8 amps for the solar electric modules and 16 amps for the wind turbines are matched by technique to total 24 amps or approximately the same as the water heater element which should not be substantially exceeded but need to be close for safety, efficiency and to operate effectively.

### B. Sizing Techniques Example for 240 Volt Single Water Tank System

| | Modules | No. | Amps | | | | | | |
|---|---|---|---|---|---|---|---|---|---|
| | Per | Of | per | Total | Total | | Total | | |
| 110 Volts | String | Strings | String | Amps | Lines | Modules | Amps | | |
| PV Production | 3 | 2 | 8.18 | 16.36 | 14 | 84 | 229.04 | amps | 229.04 |
| Wind Production | 1 | 1 | 6 | 6 | 2 | | 19 | amps | 19 |
| Total | 3 | 3 | | 22.36 | | | | amps | 267.04 |
| | | | | | | | | Volts | 118 |
| Price Per Watt Installed | | | | | | 1.826086957 | | Watts | 31510.72 |
| including water heater | | | | | | | | | |
| Wire size | | | | | | 138 | | | 1.803941643 |

| | | Wind Or | Wind Or | Wind or | PV or Wind | | |
|---|---|---|---|---|---|---|---|
| | System | Module | Module | Module | per | No. Of | Amps per |
| | Volts | Voltage | Wattage | Amps | String | Strings | String |
| PV Production | 240 | 36.1 | 300 | 1.25 | 6 | 1 | 1.25 |
| Wind Production | 110 | 120 | 500 | 4.17 | 2 | 1 | 8.3 |
| 236 Volts | | | | | 3 | 3 | |

| | | | | |
|---|---|---|---|---|
| | | | | Water |
| | | | | Heater |
| Per Line | Total | Total | Total | Element |
| Amps | Lines | Modules | Amps | Watts |

| | | | | | |
|---|---|---|---|---|---|
| PV Production | 1.36 | 5 | 30 | 6.8 | 5500 |
| Wind Production | 8.3 | 2 | 2 | 16.666667 | Element |
| 236 Volts | 10 | | | | Voltage |
| | | 7 | 32 | 23.466667 amps | 234.375 |
| | | | Volts | 240 | |
| | | | Watts | 5,520.00 | |

A third example is a 240 volt water heater element of 5500 watts each and 17.5 amps you can match as shown in Exhibit C. With 6 modules per string and 7 strings respectively the total amps are 52.5 amps respectively yielding 18,600 watts. We matched these solar electric modules with two 110 volt wind turbines in series to total 220 volts and a total of 75.5 amps. The total of 77.5 amps for the solar electric modules and 25 amps for the wind turbines are matched by technique to total 240 amps, and 4 water heaters with a total watt capacity of 18,000 watts.

### C. Sizing Techniques for 240 Volt Multiple Water Tank System with Series Wiring

| | | Wind Or | Wind Or | Wind or | PV or Wind | | | |
|---|---|---|---|---|---|---|---|---|
| | System | Module | Module | Module | per | No. Of | Amps per | Per Line |
| | Volts | Voltage | Wattage | Amps | String | Strings | String | Amps |
| PV Production | 240 | 24 | 300 | 1.25 | 6 | 7 | 7.5 | 52.5 |
| Wind Production | 120 | 24 | 300 | 12.50 | 2 | 1 | 25.0 | 25.0 |
| | | | | | 3 | 3 | | 78 |

| | | | | Water | |
|---|---|---|---|---|---|
| | | | | Heater | |
| | Total | Total | Total | Element | # |
| | Lines | Modules | Amps | Watts | 4500 |
| PV Production | 1 | 42 | 52.5 | 18000 | 4 |
| Wind Production | 1 | 2 | 25 | Element | |
| | | | | Voltage | |
| | 2 | 44 | 77.5 amps | 232.2580645 | |
| | | Volts | 240 | | |
| | | Watts | 18,600.00 | | |

This fourth system utilizes 1000 volts which is common in the solar industry. The calculated match is 27 modules of 36.1 volts each (1.25 amps each) for a total of 36 amps and 1000 volts. This analysis is shown by technique calculation (Technique) specifically Exhibit D.

### D. Sizing Techniques Example for 1000 Volt Multiple (40) Water Tank System with Series Wind/Solar

| | | Wind Or | Wind Or | Wind or | PV or Wind | | | |
|---|---|---|---|---|---|---|---|---|
| | System | Module | Module | Module | per | No. Of | Amps per | Per Line |
| | Volts | Voltage | Wattage | Amps | String | Strings | String | Amps |
| PV Production | 1000 | 36 | 300 | 0.3 | 27 | 1 | 36 | 36 |
| Wind Production | 110 | 24 | 2000 | 18.18 | 8 | 1 | 145.4 | 145.4 |
| | | | | | 3 | 3 | | 181 |

| | | | | |
|---|---|---|---|---|
| | | | Water | |
| | | | Heater | |
| Total | Total | Total | Element | # |
| Lines | Modules | Amps | Watts | 4500 |

| | | | | | |
|---|---|---|---|---|---|
| PV Production | 1 | 27 | 36 | 180000 | 40 |
| Wind Production | 1 | 2 | 145.44 | Element | |
| | | | | Voltage | |
| | 2 | 29 | 181.44 amps | 992.0634921 | |
| | | Volts | 1000 | | |
| | | Watts | 181,440.00 | | |

This fifth example, utilizes 56 volts which is common in the solar industry. The calculated match is 1 modules of 36.1 volts each (1.25 amps each) for a total of 36 amps and 1000 volts. It is matched with 1 wind turbine of 56 volts and 8.9 amps. This analysis is shown by technique calculation (Technique) specifically in Exhibit E.

### E. Sizing Techniques Example for 56 Volt Single Water Tank System

| | | | | | | | | | | Water |
|---|---|---|---|---|---|---|---|---|---|---|
| Wind Or | Wind Or | Wind or | PV or Wind | | | | | | | Heater |
| Module | Module | Module | per | No. Of | Amps per | Per Line | Total | Total | Total | Element |
| Voltage | Wattage | Amps | String | Strings | String | Amps | Lines | Modules | Amps | Wattage |
| 36.1 | 300 | 8.310249307 | 1 | 1 | 8.310249307 | 8.310249307 | 1 | 1 | 8.3102493 | 990 |
| 56 | 500 | 8.928571429 | 1 | 1 | 8.928571429 | 8.928571429 | 1 | | 8.9285714 | Element |
| | | | 3 | 3 | | 17.23882074 | | | | Voltage |
| | | | | | | | 2 | 1 | 17.238821 amps | 57.42852224 |
| | | | | | | | | Volts | 56 | |
| | | | | | | | | Watts | 965.37 | |

A sixth example is a 24 volt water heater element of 900 watts and 25 amps you can match as shown in Exhibit F. The close to ideal match is one module of 36.1 volts (8.3 amps each) for a total of 8.3 amps. This analysis is shown by technique calculation (Technique) and specifically in Exhibit F. We matched these solar electric modules with one 56 volt wind turbines in series to total 56 volts and a total of 33.33 amps in parallel. The total of 20.83 amps for the solar electric modules and 12.5 amps for the wind turbines are matched by technique to total 33 amps or approximately the same as the 27 volts of the water heater element which should not be substantially exceeded but need to be close for safety, efficiency and to operate effectively.

### F. Sizing Techniques Example for 24 Volt Single Water Tank System

| | | Wind Or | Wind Or | Wind or | PV or Wind | | |
|---|---|---|---|---|---|---|---|
| | System | Module | Module | Module | per | No. Of | Amps per |
| | Volts | Voltage | Wattage | Amps | String | Strings | String |
| PV Production | 24 | 24 | 250 | 10.41666667 | 1 | 1 | 10.41666667 |
| Wind Production | 24 | 24 | 300 | 12.50 | 1 | 1 | 12.5 |
| 24 volt | | | | | 3 | 3 | |
| Price Per Watt Installed | | | | | | | |
| including water heater | | | | | | | |
| Wire size | | | | | | | |

| | | | | | Water |
|---|---|---|---|---|---|
| | | | | | Heater |
| | Per Line | Total | Total | Total | Element |
| | Amps | Lines | Modules | Amps | Watts |
| PV Production | 10.41666667 | 2 | 2 | 20.833333 | 900 |
| Wind Production | 12.5 | 1 | 2 | 12.5 | Element |
| 24 volt | 23 | | | | Voltage |
| | | 3 | 4 | 33.333333 amps | 27 |
| | | | Volts | 24 | |
| | | | Watts | 800.00 | |
| Price Per Watt Installed | | | | 0 | |
| including water heater | | | | | |
| Wire size | | | | | |

I. This patent claim is the use of Direct Current (DC) in appliances from solar and wind electricity arrays through an energy management controller to increase electricity use, efficiency and control the operation of DC appliances. The energy management system can allow the use of Solar/Wind DC electricity in DC appliances and AC electricity in DC appliance with inverters such as computers and/or uninterruptible power supplies (DC Appliances) by measuring temperatures and controlling by high or low temperature limit Setpoint (HTSP) or (LTSP) respectively. HTSP is the highest temperature setpoint and LTSP is the lowest temperature setpoint the appliance, fluid tank such as water heater, or room air is allowed to reach. The high or low limit Setpoint also can operate on the highest or lowest volts, amps, watts, ohms, or other electrical parameter (Electrical Parameter) the appliance is allowed to reach.
Once the HTSP or LTSP set point is reached in the DC Appliance such as Fans, DC lights like LED's, the DC Heat Pump Air Conditioner and Heater with or without geothermal heat to the DC condenser, the electric resistance DC Hot Water Heater or the DC heat pump hot water heater: the controller opens up the circuit, or closes the circuit through relay's, contactor or other circuit control devices. Some of these appliances can be AC with inverters. The Device or coil interrupts or closes circuit to the nominally 120 VDC circuit above what is required to operate or when not operating DC appliance:
(a) redirecting electricity and/or
(b) sharing such electricity to other DC Appliances,
(c) battery charging, and/or
(d) inverting the electricity to Alternating Current for house use and/or utility sale or use.

II. The DC Appliance System as in claim I, the energy management controller turns on or off the electrical circuits by relays, contactors or other circuit breaking devices to the DC Appliances by program from inputs such as the (HTSP) or (LTSP) or other setpoints managing and optimizing the electrical use. The relay or contactor circuit allows the sharing of DC electricity, reduce, redirect, or limit electricity or entirely shutdown that production:
(a) above what is required to operate DC Appliances defined herein including LED lights, fans, DC heat pump air conditioners, DC heat pump heat pumps and/or DC Hot Water systems and redirecting and/or
(b) sharing such electricity to other DC Appliances,
(c) battery charging, and/or
(d) inverting the electricity to AC for house use and/or utility sale or use.

III. The DC Appliance System as in claim I, the Controller can direct in the Load Center or elsewhere the electricity to:
(a) flow through the inverter (20) and be used for a load or sold/net meter banked with the utility through the meter (24) and/or
(b) it can charge the battery or batteries using the MPPT charge controller and
(c) later be used or flow through the battery or batteries to the Load Center from the batteries,
(d) provided current electricity to DC Appliances and
(e) MPPT inverter. The Controller(s) uses various Electrical Parameters and/or temperature sensors to decide whether to open or close circuits.
(f) Switches between DC and AC current to Appliances such as the Heat Pump Air Conditioner and Heating system by use of the MPPT inverter.

IV. The DC Appliance System as in claim I, the Safety Switch will for safety, fire, O&M, operations and emergency reasons
(a) open the contactor coil and
(b) open the DC circuit and
(c) turn off the Solar PV and/or Wind array electricity production

V. The DC Appliance System as in claim I, the Solar and/or Wind Array electricity is wired or wireless sends a signal to a contactor, relay or other disconnect devise which causes the contact which has a coil or other device which opens or closes the Solar and/or Wind Array circuit by the controller signal powering the coil, contactor or other Switch device to:
(a) breaking or closing one wire of the electrical current from the Solar and/or Wind System.
(b) breaks the nominal control circuit which then opens the contactor coil and turns off the Solar PV and/or Wind array electricity production for Safety and Fire switch will for safety, fire, O&M, operations and emergency reasons can.
(c) Redirects the wind turbine production to a dump load through another contactor or relay.
(d) breaking or closing one wire of the electrical current from the Solar and/or Wind System.

VI. The DC Appliance System as in claim I, there are several safety embodiments of the patent including the following:
(a) Safety features is built in the controller has more multiple year backup battery supply which means even if the utility power goes off the controller will keep functioning and controlling the temperature and an alarm to warm about temperatures that are not extreme.
(b) The controller setting “are saved in non-volatile memory which means they will stay programmed even if the power is cut to the unit”.
(c) If utility and battery power goes off to the controller the contactor will automatically open the circuit by shutting off electricity to the coil and the Solar and Wind Array (16) stops producing electricity and the appliance stops operating.

VII. The DC Appliance System as in claim I, another features in the controller is a Hidden Access Menu Functions which is also a key safety and operation embodiment of the patent. These functions limit the temperature changes and differentials a consumer can make. The HTSP is set to 5 F below the maximum of this manufactures rating (145 F which will vary by manufacturer and design) which cannot be exceeded by the user in the Programming Temperature Set Point menu they see. The differential temperature which can be varied by programing and design is set which does not allow the Solar and Wind Array (16) to turn back on until reached. The Operating Mode, heat, or cool is set in this hidden function. The temperature unit, C or F, and calibration of that temperature can also set in this hidden menu.

VIII. The DC Appliance System as in claim I, the patent embodied system herein, however, uses Direct Current (DC) electricity for hot water, heat pump air conditioning, heat pump heating, heat pump water heating and other DC appliances with electrical wires transfers that electricity to such device. The heat is stored in an electrical hot water tank's DC heating elements to produce hot water and/or thermal heat storage in a room cooled or heated by an Air Conditioner heat pump and heater is also operated directly to the DC compressor producing cold or hot thermal storage respectively in fluid, air, or other medium by the controller
The use of an all DC electrical hot water system with DC controller, DC relays, DC battery charger, DC heat pump and compressor for air conditioning and heating, DC appliances, DC heat pump for heating water and DC heater elements is part of this embodiment.

IX. The Solar/Wind power provides electricity to a Heater or heat pump stores that hot water in conventional hot water heaters or heat pump water heater tank. The heat pump also uses geothermal energy from the ground as storage for use when its producing. Solar Electric Hot Water Heater or Heat Pump(s) comes in a wide range of voltages. One circuit is AC generator or grid connection and the other DC electric for DC appliances and they are both separate circuits as shown in FIGS. 6, 4, and 12 though they are merged herein by the system.
The DC water heater has one, two or three heater elements or DC Heat Pump compressors but alternatives with any number of elements or compressors can be used. The top two elements are connected to AC grid electricity generator, AC grid or Battery DC electricity. The bottom element or DC Heat Pump are connected to the Solar Electric Array usually but other elements or compressors in any location on the water heater tank can be connected. The DC electricity also can be connected directly to a DC compressor in Heat Pumps. Any elements or heat pump compressors on the water heater tank can be connected above to any power supply in various combinations.
Alternatively, some elements or compressors can be DC from the Solar/Wind Array (16), some dedicated to batteries, and some dedicated to AC such as generators, and/or Grid and located in any position including the bottom, middle and top of the water tank.

X. The DC Appliance System as in claim IX, any number of or types of solar Photovoltaic semi conductor materials, modules, voltages, amps or watts can be used in a system. The capacity in watts, amps and volts has been matched to the heater elements, DC appliance and/or heat pump load. The size of the Array (16) will vary. One, Two, three or more strings of 1 or more modules each are wired in series though alternative configurations can be configured. The strings and number of modules will vary. The volt produced will vary by solar manufacturer, strings, and models used. Wind turbines producing any volts or amps have also been used with this system including conventional horizontal axis, and vertical axis wind turbines.

XI. The DC Appliance System as in claim IX, electronic or Mechanical Timer Switch Controller. This system uses an electronic Time Switch or its mechanical equivalent to shutdown the backup electricity to any appliance backup hot water heater elements or heat pump by setting temperatures and/or programs by time of day. These smart controllers are combined or separate from the controller. The timer can turn off and on the electricity by the time of the day for 5 day work schedule, weekend schedule, or individual day schedule with minute accuracy. The program schedule can be by-passed completely by switching to manual operation.

XII. The DC Appliance System as in claim I, Grid or Off-Grid. We are using either Grid utility electricity or as shown off-grid Generator and Batteries to power the Controller and backup DC heater elements (8) and DC appliances. The system can operate without grid power.

XIII. A wind turbine generator attaches and is incorporated within the moving parts of a Wind Turbine Ventilator with an attachment of the generator shaft to the moving ventilator. The Wind turbine ventilator Generator attaches to the roof of a structures with a flange, and an opening on the bottom. The Wind turbine ventilator and generator ventilates the structure and/or produces electricity and/or does both simultaneously. The generator shaft is attached by flanges or other means to the ventilator that moves. The building structure is attached to the non moving parts of Ventilator or ventilator tube. The height of the wind turbine can be extended by extending the tube higher which acts as its wind turbine tower.

XIV. The Wind System as in claim XIII, the wind controller can be the same as in or separate from the DC appliances Controller, as described herein and described herein (002, 003, 014, 015, and/or 017) produces electricity to the DC load center (21), DC Appliances and/or DC Electric Water Heater, DC heat pump compressor, DC batteries (22) and/or grid (24). This system is a built in DC dump load for electricity produced from the Wind Turbine when the Appliance and Hot Water Heater storage (18) are not needing the electricity or to stop the production.

XV. The Wind System as in claim XIII, the embodiments include using any electrical generator, alternator, permanent magnet generator (PMG) or other electrical generation devise (Generator) with a wind turbine ventilator. The PMG uses a low or medium revolutions with relatively high efficiency per Revolutions Per Minute Permanent Magnetic Generator (PMG). The PMG or other Generator of any type produces electricity by its rotations as measured in RPM; the more watt power output per RPM at lower wind speeds generally the higher the efficiency. The efficiency and RPM can vary from high to low. The PMG can be cordless which starts up in low wind speeds, is highly efficient, light weight, low starting torque and compact using direct drive technology designed.

XVI. The Wind System as in claim XIII, the generator, through the controller, can be rotated (RPM) to exhaust heat at night using battery and/or Grid electricity by the controller (28) and temperature sensors.

XVII. The Wind System as in claim XIII, the Wind Array (16) electricity is wired to a contactor, relay or other disconnect devise (Contactor). The contact has a coil or other device which opens or closes contactor(s) on the Wind Array circuit. The contactor disconnects the Wind Array (16) by opening the coil and stopping electricity from flowing. It connects the circuit and allows the Solar and Wind Array (16) to produce electricity (amps, volts, watts, ohms, etc.) or redirects the electricity to other uses acting as a dump load.

XVIII. The Wind System as in claim XIII, the survival speed for the wind turbine generator is approximately 90 mile per hour meeting most building codes for structures.

IXX. The Wind System as in claim XIII, the system uses centrifuge slowing, and electromagnetic brakes and can run the generator in reverse to slow the generator in overspeed conditions. The technology embodiments for the wind turbine generator could also use feathering out of the wind by blocking the ventilator intake or the ventilator blades and mechanical brakes with this configuration. There are a Centrifugal wheel intelligence deceleration device inside the head of the generator. It will cause the wind turbine ventilator generator not to overspeed during high wind events allowing the turbine to output normally within the range of rated RPM.
